(19) United States
(12) Patent Application Publication
(10) Pub. No.: US 2014/0025844 A1
(43) Pub. Date: Jan. 23, 2014

(54) VERIFY COMMAND FOR A PERIPHERAL DEVICE

(71) Applicants: Corey Alvin Charlton, Boise, ID (US); Marvin D. Nelson, Meridian, ID (US)

(72) Inventors: Corey Alvin Charlton, Boise, ID (US); Marvin D. Nelson, Meridian, ID (US)

(21) Appl. No.: 13/551,851

(22) Filed: Jul. 18, 2012

(51) Int. Cl. G06F 3/00

(52) U.S. Cl. 710/5

(57) ABSTRACT

A verify command specifies a plurality of selected areas of a peripheral device's memory. The peripheral device is validated when data corresponding to the memory content of its plurality of selected areas of memory correspond to verified data.

### BACKGROUND

Many peripheral devices, for example printers, scanners and multi-function printers (MFP), receive firmware updates after they have been purchased. Verifying the authenticity of the firmware currently residing in the peripheral device protects the user from attacks on their peripheral devices and protects the computer systems connected to their devices.

### BRIEF DESCRIPTION OF THE DRAWINGS

FIG. 1 is an example computer system.

FIG. 2 is an example block diagram of a peripheral device.

FIG. 3 is an example block diagram of a computer.

FIG. 4 is an example block diagram of computer readable instructions loaded in memory 312.

FIG. 5 is an example flow chart for verifying the memory content of a peripheral device.

### DETAILED DESCRIPTION

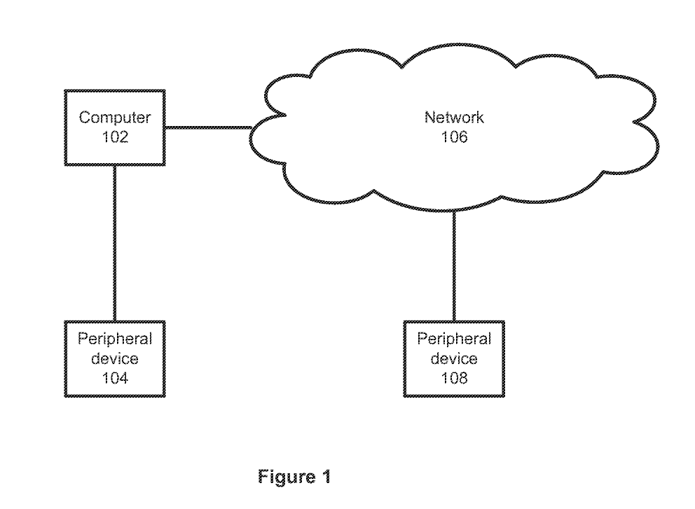

FIG. 1 is an example computer system. Computer system 100 comprises a computer 102, the Internet 106, and two peripheral devices (104, 108). Computer 102 is directly coupled to peripheral device 104. Computer 102 is indirectly coupled to peripheral device 108 through a network, for example the Internet 106. Computer 102 can be any type of computer, for example a personal computer (PC), a server, a workstation, a blade, or the like. Computer 102 may also be known as a host device. Peripheral devices 104 and 108 can be any type of peripheral device, for example a scanner, a printer, a fax machine, a multi-function peripheral (MFP), or the like.

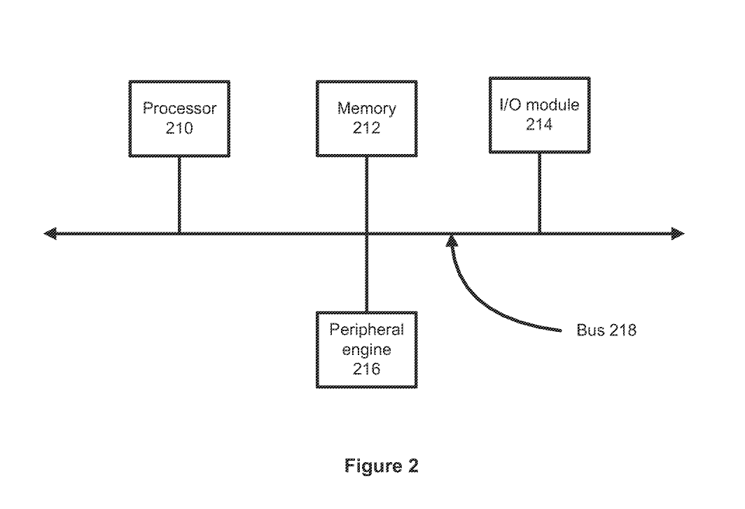

FIG. 2 is an example block diagram of a peripheral device, for example peripheral device 104 or 108. Peripheral device comprises a processor 210, memory 212, input/output (I/O) module 214, and a peripheral engine 216 all coupled together on an internal bus 218. In some examples peripheral device may also have a display, a user interface module, an input device, and the like, but these items are not shown for clarity. Processor 210 may comprise a central processing unit (CPU), a micro-processor, an application specific integrated circuit (ASIC), or a combination of these devices. Memory 212 may comprise volatile memory, non-volatile memory, and a storage device. Memory 212 is a non-transitory computer readable medium. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, and flash memory devices.

I/O module 214 is used to couple peripheral device to other devices, for example a network 106 or a computer 102. Peripheral engine 216 may be a print engine, a scan engine, a fax engine, or a combination of these types of devices. Peripheral device 200 has code, typically called firmware, stored in the memory 212. The firmware is stored as computer readable instructions in the non-transitory computer readable medium (i.e. the memory 212). Processor 210 generally retrieves and executes the instructions stored in the non-transitory, computer-readable medium to operate the peripheral device 200.

Many peripheral devices have firmware that can be updated in the field. The firmware is typically updated by downloading new firmware code into memory 212. The new firmware may be downloaded into memory 212 from a computer directly coupled to the peripheral device, or indirectly through a network. Because the firmware can be updated in the field, verifying or validating the authenticity of the firmware currently residing in the peripheral device protects the user from attacks on their peripheral devices and protects the computer systems connected to their peripheral devices.

The problem with trying to verifying the code in a peripheral device is that you have to interrogate the peripheral device to determine if the code is valid or uncompromised. The peripheral device is typically interrogated using a verify command. A host computer will send a verify command to the peripheral device. The peripheral device should respond to the verify command with an expected answer. If the code has not been compromised, the peripheral device gives you the answer you expect. If the code has been compromised, the compromised code may lie and give you the answer you expect. Therefore you can't trust the answer to a typical verify command.

The compromised code may do this in a number of ways. One way is for the compromised code to save a copy of the un-compromised code and look through it to respond to questions. Another way is to have the compromised device coupled to another similar un-compromised device and when the compromised device is asked a question, the compromised device asks the un-compromised device the question to get the correct answer. This technique is typically called man-in-the middle.

One way to overcome these problems is to ask a peripheral device multiple question where the answers are difficult (if not impossible) to anticipate. One way to make the answers difficult to anticipate is to ask random or semi-random questions. In one example a verify command uses four parameters—a starting address in memory, an ending address in memory, a burst rate ‘b’ (the amount of bytes to “select” per iteration), and a step rate ‘s’ (the amount of bytes to skip after the “selected” bytes). The algorithm begins at the start address, reads the memory content of ‘b’ bytes from memory (equal to the burst rate), and then skips ahead ‘s’ bytes in memory (equal to the step rate). It repeats this process until it reaches the end address. Because the starting address, the burst rate and the skip address are contained in the verify command, the compromised code can not anticipate the areas of code to be examined. In addition, peripheral device typically have limited memory so that the memory space of the entire device can be interrogated to insure that the “save a copy” ploy is not possible. (i.e. a memory space 212 that can be fully interrogated in a reasonable period of time).

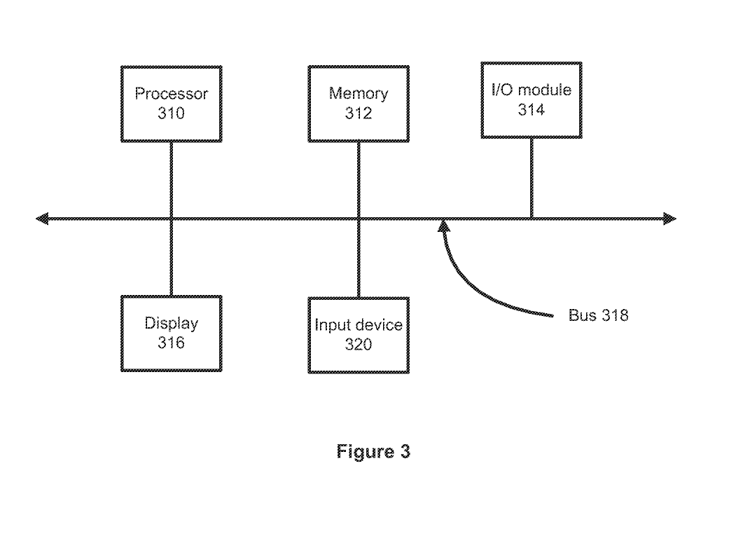

Typically a computer (also known as a host device) coupled to the peripheral device is used to send the verify command to the peripheral device. The computer may be directly connected to the peripheral device or may be indirectly connected to the peripheral device through a network. FIG. 3 is an example block diagram of a computer, for example computer 102. Computer comprises a processor 310, memory, 312, input/output (I/O) module 314, a display 316, an input device 320 (for example a keyboard or mouse), all coupled together on an internal bus 318. Processor 310 may comprise a central processing unit (CPU), a micro-processor, an application specific integrated circuit (ASIC), or a combination of these devices. Memory 312 may comprise volatile memory, non-volatile memory, and a storage device. Memory 312 is a non-transitory computer readable medium. I/O module 314 is used to couple computer 300 to other devices, for example the Internet 106 or a peripheral device 104 or 108.

Computer has code, typically called an operating system (OS), stored in the memory 312. The OS is stored as computer readable instructions in the non-transitory computer readable medium (i.e. the memory 312). Processor 310 generally retrieves and executes the OS computer readable instructions stored in the non-transitory computer-readable medium to operate computer 300. Computer 300 may also have software programs stored in memory 312 as computer readable instructions. The processor 310, in cooperation with the OS, loads and executes the software program's computer readable instructions to perform a variety of functions. One such function is to verify the authenticity of firmware currently loaded in a peripheral device coupled to the computer 300.

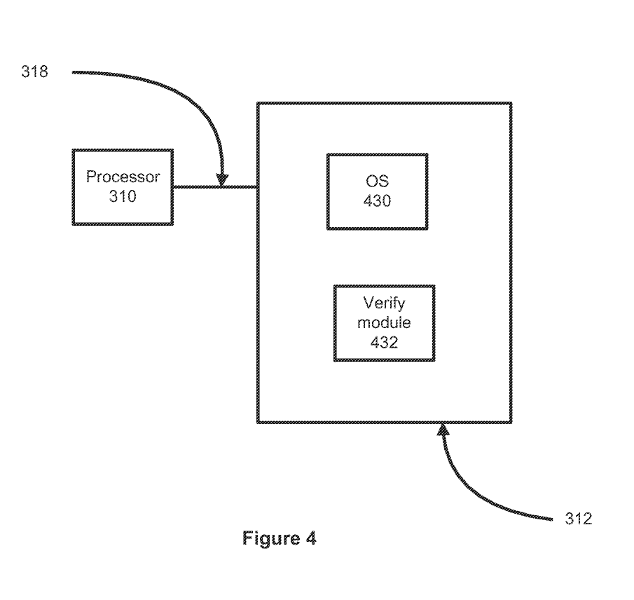

FIG. 4 is an example block diagram of computer readable instructions loaded in memory 312. The memory 312 is a non-transitory computer readable medium. A validate module 432 may be stored in the memory 312 as computer executable instructions. Processor 310 is coupled to memory 312 across bus 318. When processor 310 executes the computer readable instruction of the verify module 432, the memory content of a peripheral device will be verified.

One way to verify the firmware currently stored in the memory of a peripheral device is to check the memory content of the peripheral device to see if it has been altered by a third party. To determine if the content has been altered, a host device or computer compares the code or firmware in the memory of the peripheral device to the code or firmware from a peripheral device that is known to be uncompromised. In one example, the host computer may compare only selected sections of the memory content in a peripheral device to the memory content of an uncompromised peripheral device.

By using only selected sections of memory from the peripheral device to check the current contents of memory, the memory content are checked in a semi-random manner which cannot be reproduced without an uncompromised device. Even though only selected sections of memory from the peripheral device are checked, there is still enough data gathered by the host, through multiple requests to the device, to determine that the firmware and system call tables of the peripheral device have not been altered.

To check the integrity of a peripheral device's static elements, a verify command would be sent to the peripheral device from a host device where the verify command contains the selected areas of memory to check. In one example the selected areas of memory would be specified using a start address, an end address, a step rate, and a burst rate. The peripheral device would then run the verify algorithm and return the data collected. This data would be sent back to the computer, which could validate the data against data returned by a trusted device (one that can be assumed to be un-compromised). If the data is verified, the peripherals device's integrity can be validated.

The data returned by the peripheral device may be the contents of the areas of memory specified in the verify command. If the area of memory specified by the verify command included the image of the firmware for the peripheral device, the data would include the actual firmware code. Some manufactures may not want the actual code content of their devices to be accessible. Therefore in some examples the data returned by the peripheral device may be a hash or a cyclic redundancy check (CRC) of the memory content specified in the verify command.

In one example one or more verify commands are used to check the integrity of the firmware code image. In this example, for each verify command, the values for the start address and end address would include the firmware program's code segment. Since the code segment should be static and does not get changed during normal use of the peripheral device, using any reasonable value for the step rate and burst rate should yield data which is unique to each firmware version, but is the same on all peripheral devices using that firmware version. Typically each verify command would use a different set of values.

In another example, the verify command may check certain sections of the peripheral device's memory, like system call tables, which can be altered to inject third party code. In this example, for each verify command, the values for start and end address include a specific region of the peripheral device's memory which is used to store the system call table. The values for the step rate and burst rate can be set to gather data which is important in determining the integrity of the call table.

To validate the dynamic behavior of a peripheral device, a similar verify command would be sent to the peripheral device from a remote client, but this verify command would also include a runtime function for the peripheral device to execute and (optionally) an indicator to specify whether a reboot of the peripheral device will be required after the operation. The peripheral device would first execute the runtime function to put it in a deterministic state before running through the verify algorithm and returning the data. This data could then be checked against data returned by a trusted device to validate the system. Since some runtime functions may cause the peripheral device to be in an unusable state after they've been executed, the reboot indicator can be supplied to force the peripheral device to reboot after returning the data.

When using the verify command with a runtime function, the verify command would investigate the peripheral device's processor registers which are mapped into the memory space for the peripheral device. The memory space that maps the peripheral device's processor registers is a dynamic area of memory (i.e. the memory content changes when the peripheral device is operating). After executing the runtime function passed in as a parameter to the verify command, these registers will contain data from when the processor in the peripheral device was executing commands. Some registers are not fully specified in that some bits always return a 1 or a 0. This makes it difficult for a compromised device to fabricate the correct answer unless they are running the code on real hardware. Immediately after running specific functions on the peripheral device to put it in a deterministic state, the verify command can be run with the start address and end address within the memory-mapped register space. The data returned by the command can then be interpreted to validate the integrity of the peripheral device.

The runtime function included in the verify command may load the processor registers with specific information that is unique to the hardware of the peripheral device. Typically each peripheral device contains a number of hardware unique values loaded into the read only memory (ROM) or the random access memory (RAM) of the peripheral device. These hardware unique values may include a serial number, a peripheral engine identification number (ID), the IP address of the peripheral device, the network interface card (NIC) ID, a universal identification number (UID) for the peripheral device, and the like. The runtime function can randomly select one or more of these hardware unique values, and load them into one or more of the processor registers. The verify command can include the register areas of memory in the selected area of memory to send back to the host to be verified. By evaluating the register space when loaded with unique hardware values, the verify command checks that the device returning the value is also the device executing the runtime command.

In some examples the start memory address, the end memory address, the burst rate, and the skip amount, may be randomly selected. The random selection may be between set boundaries. For example the starting address may be randomly selected in the first portion of the peripheral device's memory space. lithe peripheral device has a memory space of 10 Mbytes, the starting address may be randomly selected in the first section of the memory space, for example the first 5% of the memory space (the first 500 Kbytes). In other examples the starting address may be selected from within the first 80% of the memory space. The end memory address, the burst rate, and the skip amount may also be selected in this manner.

In other examples, different areas in the memory of the peripheral device are targeted for verification, for example the call tables, the register space, the code image and the like. However the specific parts of these different areas are randomly determined by the burst rate and step amount. Therefore the areas in memory may be semi-randomly determined.

In other examples, the memory content of the peripheral device may be selected using a different method. For example, the skip amount between the different areas of memory to be checked may not be a constant. The skip amount may change between each section of memory that will be checked. In one example, a variance parameter may be sent in the verify command. The variance parameter may be a multiplication factor, or an additive variance amount to be applied to the skip amount after each section of memory is selected. The burst amount can also be variable.

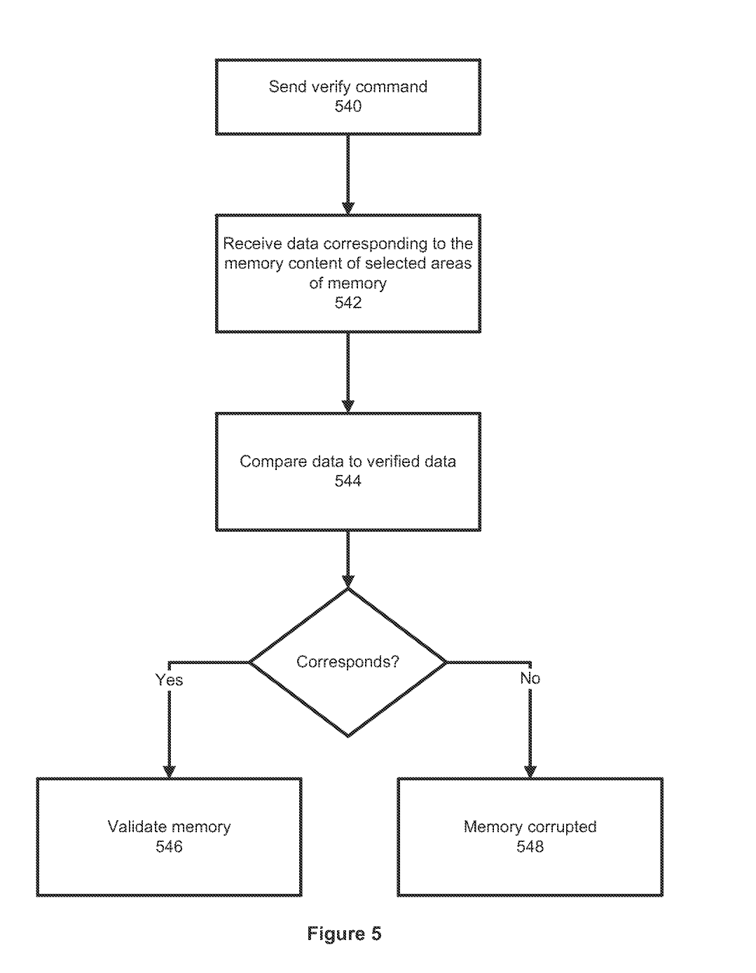

FIG. 5 is an example flow chart for verifying the memory content of a peripheral device. Flow starts at step 540 when a host device sends a verify command to a peripheral device. The verify command specifies a number of selected areas of memory in the peripheral device. At step 542 the host device receives the data from the memory content of the selected areas of the peripheral device's memory. The data may be the actual memory content or a hash or CRC of the memory content. At step 544 the host device compares the data from the peripheral device to the data of the same selected areas of a known good peripheral device. When the data from the peripheral device matches the data of the same selected areas of a known good peripheral device flow continues at step 546 where a memory validated message is sent to the peripheral device. When the memory content from the peripheral device does not match the memory content of the same selected areas of a known good peripheral device flow continues at step 548 where a memory corrupted message is sent to the peripheral device.

In some examples the verify command sent in step 540 may contain a runtime function that will be executed by the peripheral device before the memory content is selected. A reboot indicator may also be included in the verify command if a reboot of the peripheral device is desired once the verify command has been executed. Multiple verify commands specifying different areas of memory may also be used before the peripheral device is validated. In one example, a verify command may contain multiple sets of starting addresses, burst rates, skip rates and end addresses. In this way the step rate and burst rate can be different for different areas in the memory of the peripheral device.

What is claimed is:

1. A computer, comprising:
a processor;
an input/output (I/O) module coupled to the processor, the I/O module to couple to a peripheral device;
the processor to send a verify command to the peripheral device wherein the verify command specifies a plurality of selected areas of memory in the peripheral device and the plurality of selected areas of memory are semi-randomly determined;
the processor to receive data from the peripheral device corresponding to memory content of the plurality of selected areas of memory;
the processor to compare the data to verified data;
the processor to validate the peripheral device when the data corresponds to the verified data.

2. The computer of claim 1, wherein the I/O module is to indirectly couple to the peripheral device.

3. The computer of claim 1, wherein the verified data is data corresponding to the memory content for the plurality of selected areas of memory of a known good peripheral device.

4. The computer of claim 1, wherein the verify command includes a runtime function to be executed by the peripheral device before the peripheral device collects the data corresponding to the memory content of the plurality of selected areas of memory.

5. The computer of claim 4, wherein the runtime function, when executed by the peripheral device, loads at least one hardware unique value into a register of the peripheral device before the peripheral device collects the data corresponding to the memory content of the plurality of selected areas of memory.

6. The computer of claim 1, wherein the verify command includes a starting memory address, a BurstAmount, a StepAmount and a stop memory address, and the memory content is determined by:
setting a current memory address to the staring memory address and then selecting the memory content for the BustAmount of memory addresses;
a) skiping the StepAmount of memory addresses and setting a next memory address as the current memory address;
b) when the current memory address is less that the stop memory address then selecting the memory content for the BustAmount of memory addresses;
repeating steps a) and b) until the current memory address is greater than the stop memory address.

7. A computer, comprising:
a processor;
a non-transitory computer readable medium coupled to the processor,
computer executable instructions stored in the non-transitory computer readable medium, that when executed by the processor, causes the compute to perform the following steps:
sending a verify command to a peripheral device where the verify command specifies a plurality of selected areas of memory in the peripheral device wherein the plurality of selected areas of memory are semi-randomly determined;
receiving data from the peripheral device corresponding to memory content of the plurality of selected areas of memory;
comparing the data from the peripheral device to verified data;
validating the peripheral device when the data from the peripheral device corresponds to the verified data.

8. The computer of claim 7, wherein the computer is indirectly coupled to the peripheral device.

9. The computer of claim 7, wherein the verified data is data that corresponds to the memory content for the plurality of selected areas of memory of a known good peripheral device.

10. The computer of claim 7, wherein the verify command includes a runtime function to be executed by the peripheral device before the peripheral device collects the data corresponding to the memory content of the plurality of selected areas of memory.

11. The computer of claim 10, wherein the verify command includes a reboot indicator that, when set, causes the peripheral device to reboot after responding to the verify command.

12. The computer of claim 10, wherein the runtime function, when executed by the peripheral device, loads at least one hardware unique value into a register of the peripheral device before the peripheral device collects the data corresponding to the memory content of the plurality of selected areas of me.

13. The computer of claim 7, wherein the selected areas of memory include static areas of memory and dynamic areas of memory.

14. The computer of claim 7, wherein the selected areas of memory are separated by a variable number of memory addresses.

15. A peripheral device, comprising:
a processor;
an input/output (I/O) module coupled to the processor, the I/O module to indirectly couple to a computer;
memory coupled to the processor, the memory containing computer readable instructions that, when executed by the processor, cause the peripheral device to operate;
the processor to receive a verify command wherein the verify command specifies a plurality of selected areas of memory in the peripheral device;
the processor to send data from the peripheral device in response to the verify command where the data corresponds to memory content of the plurality of selected areas of memory.

16. The peripheral device of claim 15, wherein the verify command includes a reboot indicator that, when set, causes the peripheral device to reboot after responding to the verify command.

17. The peripheral device of claim 15, wherein the verify command includes a runtime function to be executed by the peripheral device before the peripheral device collects the data corresponding to the memory content of the plurality of selected areas of memory.

18. The peripheral device of claim 17, wherein the runtime function, when executed by the peripheral device, loads at least one hardware unique value into a register of the peripheral device before the peripheral device collects the data corresponding to the memory content of the plurality of selected areas of memory.
